(19) United States
(12) Patent Application Publication
(10) Pub. No.: US 2005/0232334 A1
(43) Pub. Date: Oct. 20, 2005

(54) Temperature sensor

(75) Inventors: Yun-Ching Ma, Pingtung City (TW); Zack Lin, Sindian City (TW); Ching-Han Yu, Fonglin Township (TW)

Correspondence Address: SEYFARTH SHAW, 55 EAST MONROE STREET, SUITE 4200, CHICAGO, IL, 60603-5803, US

(73) Assignee: Polytronics Technology Corporation, Hsinchu (TW)

(21) Appl. No.: 11/031,814

(22) Filed: Jan. 6, 2005

(30) Foreign Application Priority Data
Apr. 16, 2004 (TW) 093110709

(51) Int. Cl. G01K 7/00

(52) U.S. Cl. 374/185

(57) ABSTRACT

A temperature sensor comprises at least one temperature sensing device and a sensing circuit. The temperature sensing device comprises a first electrode layer, a second electrode layer and a current-sensitive layer, wherein at least one of the first and second electrode layers comprises two electrically separated electrode plates, and the current-sensitive layer is laminated between the first and second electrode layers. The current-sensitive layer is made of PTC or NTC material, and the sidewalls are not plated with conductive films. The sensing circuit is electrically coupled to the temperature sensing device to read temperatures.

### BACKGROUND OF THE INVENTION

(A) Field of the Invention The present invention is related to a temperature sensor, more specifically, to a temperature sensor using thermistors.

(B) Description of the Related Art

The resistance of a thermistor is quite sensitive to temperature variation, and thermistors can be roughly categorized into two groups, i.e., those having positive temperature coefficient (PTC) and those having negative temperature coefficient (NTC). For PTC material, its resistance can be kept extremely low at normal operation so that the circuit can operate normally. However, if an over-current or an over-temperature event occurs, the resistance will immediately increase to a high resistance state (e.g., above 10⁴ ohm.) Therefore, the over-current will be reversely eliminated and the objective to protect the circuit device can be achieved. Accordingly, the resistance of the PTC material ramps up as temperature increases, and in contrast, the resistance of the NTC material ramps down as temperature increases. The resistance vs. temperature characteristic curves of PTC and NTC materials are shown in FIG. 1(a).

For a thermistor of a known littlefuse type, because the solderability height has to be taken into account when soldering, the sidewalls of the thermistor need to be roll-plated with conductive films. Referring to FIG. 1(b), for mass production of PTC devices, a plurality of trenches 12 are formed in a PTC material plate 11 by routing or punching, so that the sidewalls of the trenches 12 can be roll-plated with conductive films. Then, the PTC material plate 11 is cut laterally along the direction perpendicular to the trenches 12, so as to form a plurality of PTC devices 13.

Accordingly, in view of the solderability height problem of littlefuse type device, it is necessary to form trenches in the raw material plate, e.g., a PTC material plate, and the sidewalls of the trenches have to be plated with conductive films. As a result, the manufacturing process becomes more complex and the cost becomes higher; therefore the applications for temperature measurement using PTC devices will be limited.

### SUMMARY OF THE INVENTION

Using the temperature-sensitive feature of PTC and NTC materials, a temperature sensor is made in accordance with the present invention, thereby providing another application in addition to over-current protection for a thermistor.

The objective of the present invention is to provide a temperature sensor, which can be made to be of adequate size and accuracy-adjustable. Furthermore, the process for manufacturing the temperature sensor is rather simple, so the cost can be lowered.

For achieving the above objective, a temperature sensor is disclosed, which comprises at least one temperature sensing device and a sensing circuit. The temperature sensing device comprises a first electrode layer, a second electrode layer and a current-sensitive layer, wherein at least the first or second electrode layer comprises two electrically separated electrode plates, and the current-sensitive layer is laminated between the first and second electrode layers. The current-sensitive layer can be made of PTC or NTC material, and the sidewalls of the current-sensitive layer are not plated with conductive films. The sensing circuit is electrically coupled to the temperature sensing device for signal conversion, so as to read temperatures.

If only one electrode layer is constituted of two separated electrode plates, and the other is in one piece, the electrode layer in one piece is used for accessing or contacting a body to be tested, so as to sense the temperature of the body. If both the first and second electrode layers comprise two electrically separated electrode plates, the orientation of the temperature sensing device is not limited when being assembled to be a temperature sensor.

### BRIEF DESCRIPTION OF THE DRAWINGS

FIG. 1(a) illustrates the temperature vs. resistance characteristic curves of known PTC and NTC materials;

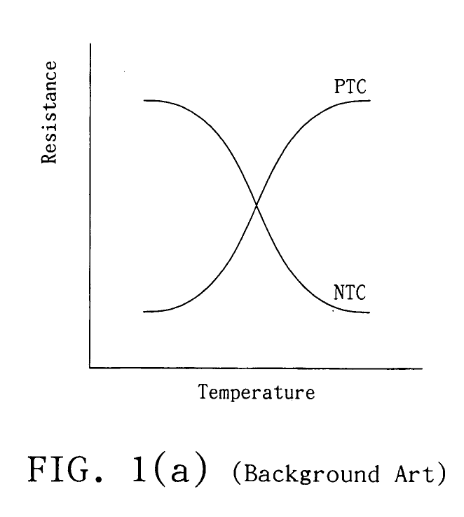

FIG. 1(b) illustrates a known process for manufacturing thermistors;

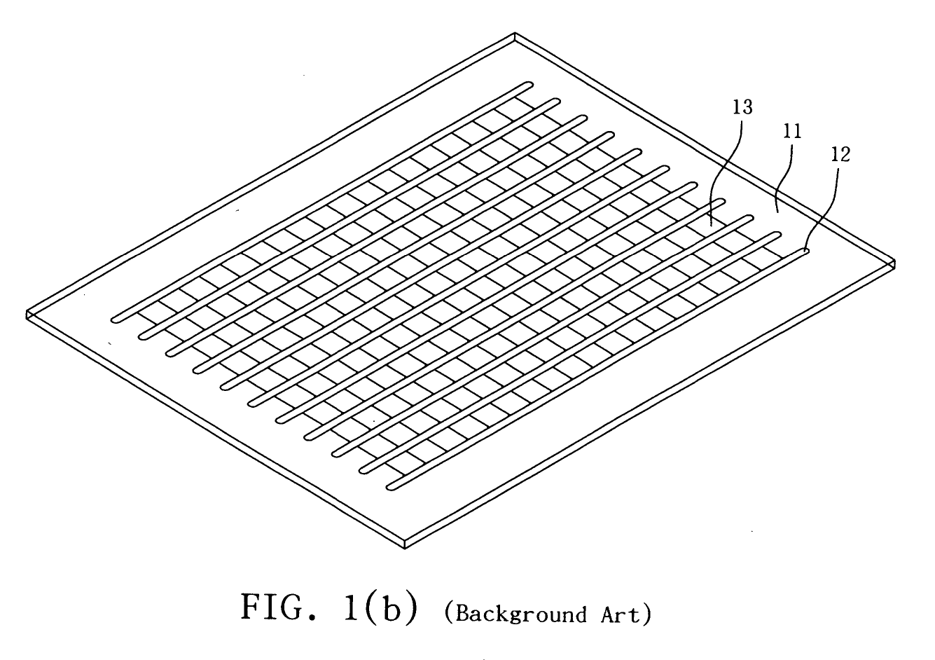

FIGS. 2(a) through 2(c) illustrate a temperature sensing device of an embodiment in accordance with the present invention;

FIGS. 3(a) through 3(c) illustrate a temperature sensing device of another embodiment in accordance with the present invention;

FIG. 4 illustrates the manufacturing method of temperature sensors in accordance with the present invention; and

FIG. 5 illustrates the temperature sensor in accordance with the present invention.

### DETAILED DESCRIPTION OF THE INVENTION

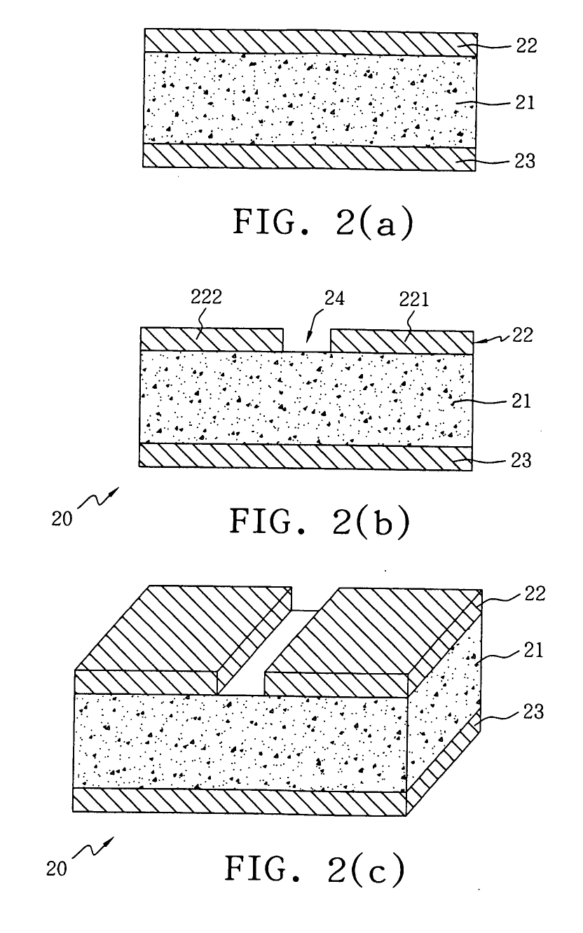

FIGS. 2(a) through 2(c) illustrate the temperature sensor of an embodiment of the present invention. Referring to FIG. 2(a), a current-sensitive layer 21 is laminated between a first electrode layer 22 and a second electrode layer 23, and then a trench 24 is formed in the first electrode layer 22 by etching or other ways. Consequently, a temperature sensing device 20 is formed, of which the first electrode layer 22 is divided into two electrode plates 221 and 222 as shown in FIGS. 2(b) and 2(c). FIG. 2(c) illustrates the perspective view of the temperature sensing device 20. The temperature sensing device 20 is designated as type “A.”

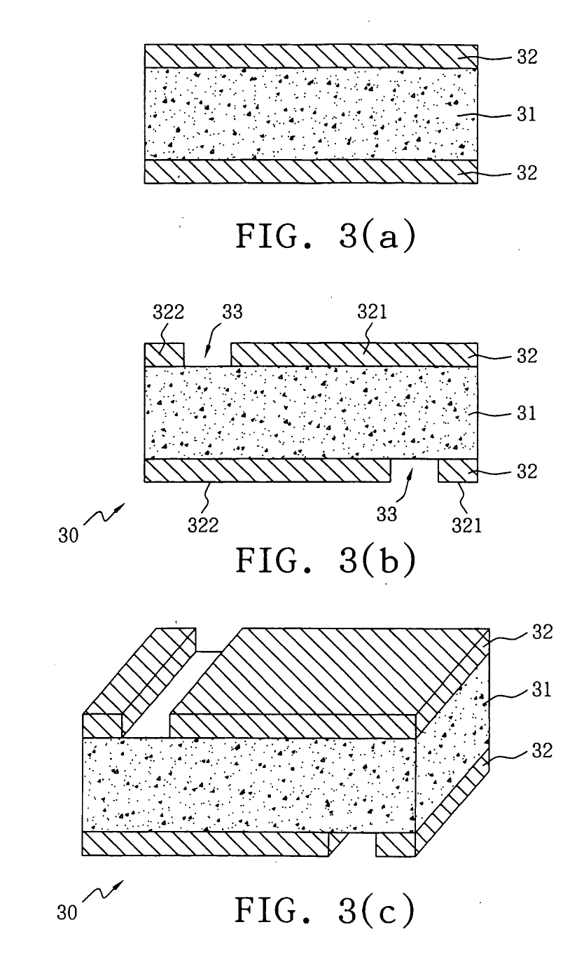

FIGS. 3(a) and 3(b) illustrate the manufacturing process of the temperature sensing device of another embodiment. First, a current-sensitive layer 31 is laminated between two electrode layers 32, and then two trenches 33 are formed in the electrode layers 32 by etching or the other ways, so that each electrode 32 is divided into two electrode plates 321 and 322. Consequently, a temperature sensing device 30 of another type as shown in FIG. 3(c) is formed. The temperature sensing device 30 is designated as type “B.”

In fact, the above-mentioned temperature sensing devices 20 and 30 are similar to devices of littlefuse type in view of structure. However, the sidewalls of the temperature sensing devices 20 and 30, i.e., the surfaces without electrode layers, need not consider the problem of solderability height, so that the process of roll-plating conductive films on the sidewalls can be omitted.

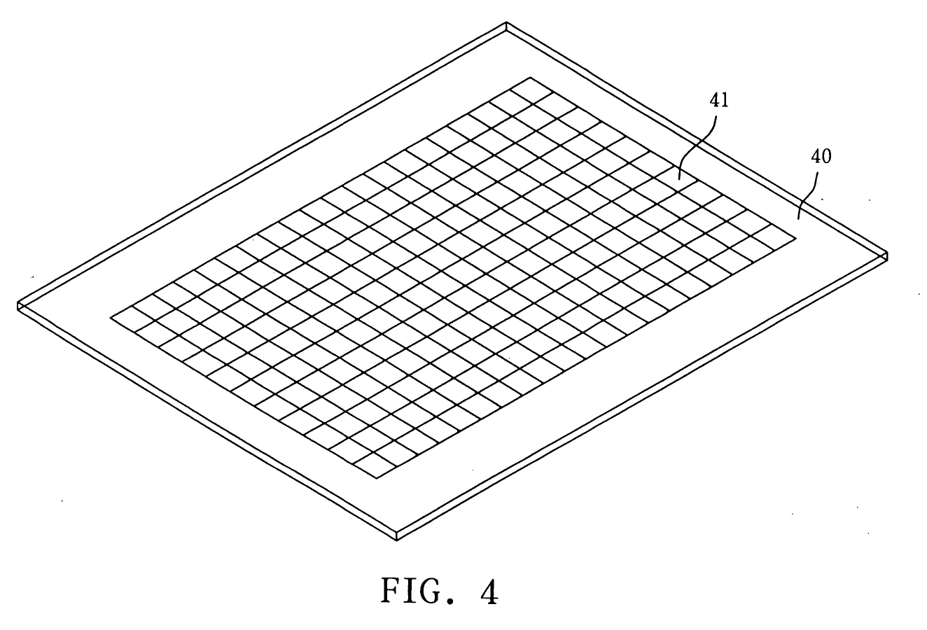

Referring to FIG. 4, for manufacturing the temperature sensing device, no trench in a current-sensitive plate 40 made of PTC or NTC materials is needed, and the current-sensitive plate 40 is cut directly to form a plurality of temperature sensing devices 41. Therefore, the process in accordance with the present invention is simpler than that of prior skills, so that the cost can be lowered.

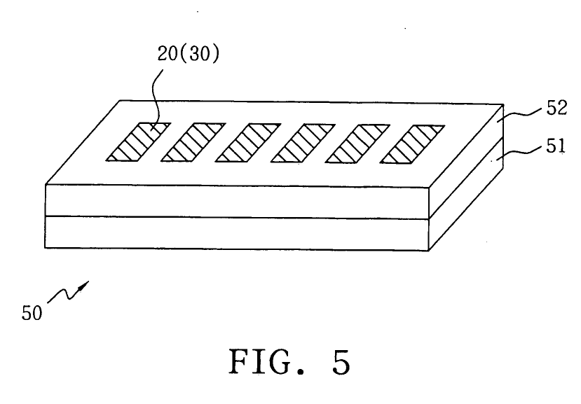

Referring to FIG. 5, the plurality of temperature sensing devices 20 or 30 are aligned and secured on a sensing circuit 51 and surrounded by adequate protective material 52 to form a temperature sensor 50. The number, the interval and disposition of the temperature sensing devices 20 or 30 can be adjusted according to the requirements, and the temperature sensing devices 20 or 30 of different types can be integrated into a temperature sensor 20 or 30. The sensing circuit 51, which can be manufactured in a printed circuit board (PCB) or a flexible printed circuit (FPC), is used for converting and processing the signals sensed by the temperature sensing device 20 or 30, so as to read temperatures. The second electrode layer 23 without a trench of the temperature sensing device 20 of type “A” is used for accessing a body and sensing the temperature thereof, whereas the other electrode layer 22, including electrode plates 221 and 222 with a trench therebetween, is coupled to the sensing circuit 51 to transmit sensing signals. The temperature sensing device 30 of type “B” is a symmetrical structure, so that the orientation of the temperature sensing device 30 is not limited when being assembled. In this embodiment, the temperature sensor 50 has a length of 50 mm, a width of 7.5 mm and a height of 1.6 mm. The dimensions of the temperature sensing devices 20 and 30 are not limited, and are dependent upon the position and size of a body to be sensed.

The current-sensitive layers 21 or 31 can be made of PTC or NTC materials. In the above embodiment, the temperature sensing device 20 or 30 has a length of approximately 3.2 mm and a width of approximately 2.4 mm. As usual, the temperature sensing device 20 or 30 has a length between 2.5 to 4 mm and a width between 1.8 to 3 mm.

The above-described embodiments of the present invention are intended to be illustrative only. Numerous alternative embodiments may be devised by those skilled in the art without departing from the scope of the following claims.

1. A temperature sensor, comprising:
at least one temperature sensing device, comprising:
a first electrode layer comprising two electrically separated electrode plates;
a second electrode layer; and
a current-sensitive layer laminated between the first and second electrode layers and being made of positive temperature coefficient (PTC) or negative temperature coefficient (NTC) material, wherein the sidewalls of the current-sensitive layer are not plated with conductive films; and
a sensing circuit electrically coupled to the temperature sensing device for reading temperatures.

2. The temperature sensor of claim 1, wherein the temperature sensing device is cut from a current-sensitive plate, and no trench is formed in the current-sensitive plate for plating conductive films.

3. The temperature sensor of claim 1, wherein the second electrode layer is used for accessing a body, so as to sense the temperature of the body.

4. The temperature sensor of claim 1, wherein the second electrode layer comprises two electrically separated electrode plates.

5. The temperature sensor of claim 1, wherein the first electrode layer is divided into two electrically separated electrode plates by etching.

6. The temperature sensor of claim 1, wherein the sensing circuit is formed in a printed circuit board.

7. The temperature sensor of claim 1, wherein the sensing circuit is formed in a flexible printed circuit.

8. The temperature sensor of claim 1, wherein the temperature sensing device has a length of 2.5 to 4 mm and a width of 1.8 to 3 mm.

9. The temperature sensor of claim 1, wherein a plurality of temperature sensing devices are aligned.
